(19) United States
(12) Patent Application Publication
(10) Pub. No.: US 2008/0248746 A1
(43) Pub. Date: Oct. 9, 2008

(54) Diversity System for Transmitting a Signal with Sub-Carriers

(75) Inventor: Hendricus Clemens De Ruijter, Sunnyvale, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,383

(22) PCT Filed: Jan. 25, 2005
(86) PCT No.: PCT/IB2005/050300

§ 371 Date: Jul. 24, 2006

(30) Foreign Application Priority Data
Jan. 28, 2004 (EP) 04100288.2

(51) Int. Cl. H04J 3/00; H04B 7/24

(52) U.S. Cl. 455/39

(57) ABSTRACT

In diversity systems (3) for transmitting signals (4) comprising sub-carriers from first units (1) to second units (2,2a), receivers (22,22a) coupled to antennas (25,26) located at different positions for receiving the signals (4) are provided with transforming modules (38,38a) for converting received antenna signals into sub-carrier-vectors per sub carrier and per antenna (25.26) and processing modules (39,39a) for processing the sub-carrier-vectors per sub-carrier. Then, the received antenna signals are no longer splitted into arbitrary sub-bands, but they are splitted in accordance with the sub-carriers already present in the signal (4) to be transmitted. For transmitting return signals (5) comprising sub-carriers from the second units (2,2a) to the first units (1), transmitters (21,21a) coupled to antennas (25,26) located at different positions for transmitting the return signals (5) are provided with reverse processing modules (49) for generating sub-carrier-vectors per sub-carrier and per antenna and with reverse transforming modules (48,48a) for converting the sub-carrier-vectors into antenna signals to be transmitted. The overall throughput of the diversity system (3) is improved.

The invention relates to a diversity system for transmitting a signal comprising at least two sub-carriers from a first unit to a second unit, and also relates to a unit, a method and a processor program product for receiving a signal comprising at least two sub-carriers from a further unit, and further relates to a transforming module and a processing module for use in a unit.

Examples of such a diversity system are orthogonal frequency division multiplexing systems like wireless networks.

A prior art diversity system is known from U.S. Pat. No. 5,528,581, which discloses in its FIG. 5 a receiver coupled to antennas, a front-end per antenna, a fast fourier transformer per front-end, and a combiner per fast fourier transformer. Each fast fourier transformer splits its input signal into a first sub-band signal, a second sub-band signal, a third sub-band signals etc. and a first, second, third combiner combines all first, second, third sub-band signals into a first, second, third combined sub-band signal to be further processed. To reduce the complexity, each fast fourier transformer may split its input signal into a lower number of sub-band signals, in which case however separators need to be introduced behind the combiners.

The known diversity system is disadvantageous, inter alia, due to being relatively complex: either the received antenna signals need to be splitted into a relatively large number of sub-bands, or, in case of these received antenna signals being splitted into a lower number of sub-bands, separators need to be introduced.

It is an object of the invention, inter alia, to provide a diversity system which can handle received antenna signals each comprising at least two sub-carriers in a relatively low complex way.

Furthers objects of the invention are, inter alia, to provide a unit, a method and a processor program product which can handle received antenna signals each comprising at least two sub-carriers in a relatively low complex way, and to provide a transforming module and a processing module for use in a unit.

The diversity system according to the invention is defined by transmitting a signal comprising at least two sub-carriers from a first unit to a second unit, which first unit comprises a transmitter for transmitting the signal, which second unit comprises a receiver coupled to at least two antennas located at different positions for receiving the signal, which receiver comprises a transforming module for converting received antenna signals into sub-carrier-vectors per sub-carrier and per antenna and a processing module for processing the sub-carrier-vectors per sub-carrier.

By introducing a transforming module for converting received antenna signals into sub-carrier-vectors per sub-carrier and per antenna, the received antenna signals are no longer splitted into arbitrary sub-bands, but they are splitted in accordance with the sub-carriers already present in the signal to be transmitted. In other words, according to the invention, the received antenna signals are splitted in accordance with borderlines naturally present. The processing module processes the sub-carrier-vectors per sub-carrier. As a result, at a relatively low complexity, the diversity system will have an improved overall throughput.

An embodiment of the diversity system according to the invention is defined by the transforming module converting, during a first time-interval, first antenna signals received via a first antenna and converting, during a second time-interval, second antenna signals received via a second antenna. This transforming module is used in a time-multiplexed way, which allows one transformer in the transforming module to be used advantageously for two or more antennas.

An embodiment of the diversity system according to the invention is defined by further transmitting a return signal comprising at least two sub-carriers from the second unit to the first unit, which first unit further comprises a receiver for receiving the return signal, which second unit further comprises a transmitter coupled to at least two antennas located at different positions for transmitting the return signal, which transmitter comprises a reverse processing module for generating sub-carrier-vectors per sub-carrier and per antenna and a reverse transforming module for converting the sub-carrier-vectors into antenna signals to be transmitted. Then, the results of the converting and the processing of the received antenna signals are used in the reverse processing module and in the reverse transforming module for creating the antenna signals to be transmitted. This all takes place in the second unit, and, as an advantageous result, the first unit does no longer need to get a receiver having a transforming module and a processing module (such a receiver would be necessary for improving a-reception of the return signal in correspondence with an improvement of a reception of the signal). In this case, the second unit for example corresponds with a kind of base station, which may be more expensive and which may have a larger power consumption than the first unit, which for example corresponds with a mobile terminal. Of course, in case of both units each comprising all four modules, the diversity system will show an even more improved overall throughput. Preferably, but not exclusively, the receiver and the transmitter in a unit are both coupled to the same antenna pair, via an antenna switch, an antenna splitter or an antenna duplexer etc. However, even in case of the receiver and the transmitter being coupled to different antenna pairs, the overall throughput of the diversity system will be improved compared to diversity systems not comprising such modules.

An embodiment of the diversity system according to the invention is defined by the reverse transforming module converting, during a first time-interval, first sub-carrier-vectors into first antenna signals to be transmitted via a first antenna and converting, during a second time-interval, second subcarrier-vectors into second antenna signals to be transmitted via a second antenna. This reverse transforming module is used in a time-multiplexed way, which allows one inverse transformer in the reverse transforming module to be used advantageously for two or more antennas.

The unit according to the invention for receiving a signal comprising at least two sub-carriers from a further unit comprises a receiver coupled to at least two antennas located at different positions for receiving the signal, which receiver comprises a transforming module for converting received antenna signals into sub-carrier-vectors per sub-carrier and per antenna and a processing module for processing the sub-carrier-vectors per sub-carrier.

An embodiment of the unit according to the invention is defined by the transforming module converting, during a first time-interval, first antenna signals received via a first antenna and converting, during a second time-interval, second antenna signals received via a second antenna.

An embodiment of the unit according to the invention for further transmitting a return signal comprising at least two sub-carriers to the other unit further comprises a transmitter coupled to at least two antennas located at different positions for transmitting the return signal, which transmitter comprises a reverse processing module for generating sub-carrier-vectors per sub-carrier and per antenna and a reverse transforming module for converting the sub-carrier-vectors into antenna signals to be transmitted.

An embodiment of the unit according to the invention is defined by the reverse transforming module converting, during a first time-interval, first sub-carrier-vectors into first antenna signals to be transmitted via a first antenna and converting, during a second time-interval, second sub-carrier-vectors into second antenna signals to be transmitted via a second antenna.

The method according to the invention for receiving a signal comprising at least two sub-carriers via at least two antennas located at different positions comprises a transforming step for converting received antenna signals into sub-carrier-vectors per sub-carrier and per antenna and a processing step for processing the sub-carrier-vectors per sub-carrier.

The processor program product according to the invention for receiving a signal comprising at least two sub-carriers via at least two antennas located at different positions comprises a transforming function for converting received antenna signals into sub-carrier-vectors per sub-carrier and per antenna and a processing function for processing the sub-carrier-vectors per sub-carrier.

The transforming module according to the invention for use in a unit for receiving a signal comprising at least two sub-carriers from a further unit, which unit comprises a receiver coupled to at least two antennas located at different positions for receiving the signal, is defined in that the receiver comprises the transforming module for converting received antenna signals into sub-carrier-vectors per sub-carrier and per antenna and a processing module for processing the sub-carrier-vectors per sub-carrier.

The processing module according to the invention for use in a unit for receiving a signal comprising at least two sub-carriers from a further unit, which unit comprises a receiver coupled to at least two antennas located at different positions for receiving the signal, is defined in that the receiver comprises a transforming module for converting received antenna signals into sub-carrier-vectors per sub-carrier and per antenna and the processing module for processing the sub-carrier-vectors per sub-carrier.

Embodiments of the method according to the invention and of the processor program product according to the invention and of the transforming module according to the invention and of the processing module according to the invention correspond with the embodiments of the diversity system according to the invention.

The invention is based upon an insight, inter alia, that the received antenna signals should not be splitted into arbitrary sub-bands in case of sub-carriers being present in the signal to be transmitted, and is based upon a basic idea, inter alia, that the received antenna signals are to be splitted in accordance with the subcarriers already present in the signal to be transmitted.

The invention solves the problem, inter alia, to provide a diversity system which can handle received antenna signals each comprising at least two sub-carriers in a relatively low complex way, and is advantageous, inter alia, in that the diversity system will have an improved overall throughput.

These and other aspects of the invention will be apparent from and elucidated with reference to the embodiments(s) described hereinafter.

In the drawings:

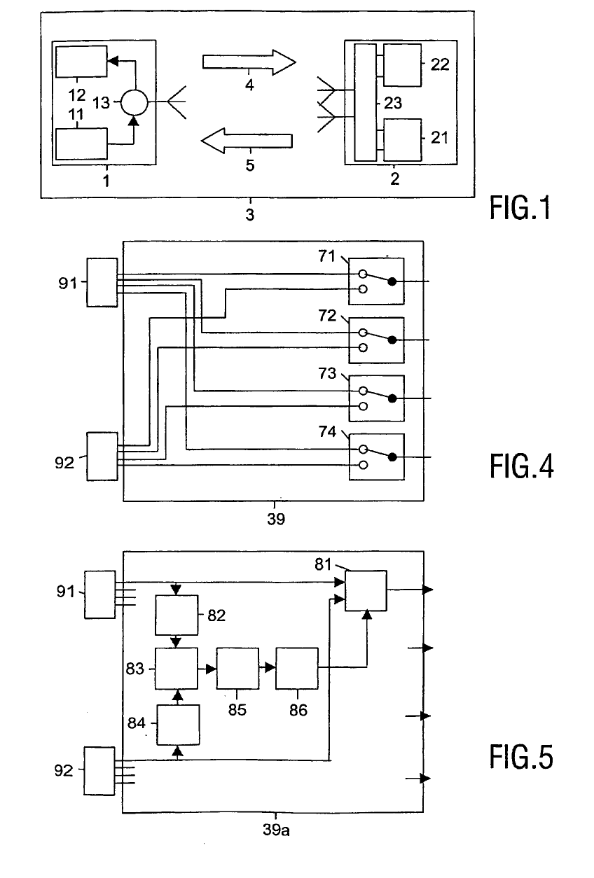

FIG. 1 shows in block diagram form a diversity system according to the invention comprising a unit according to the invention;

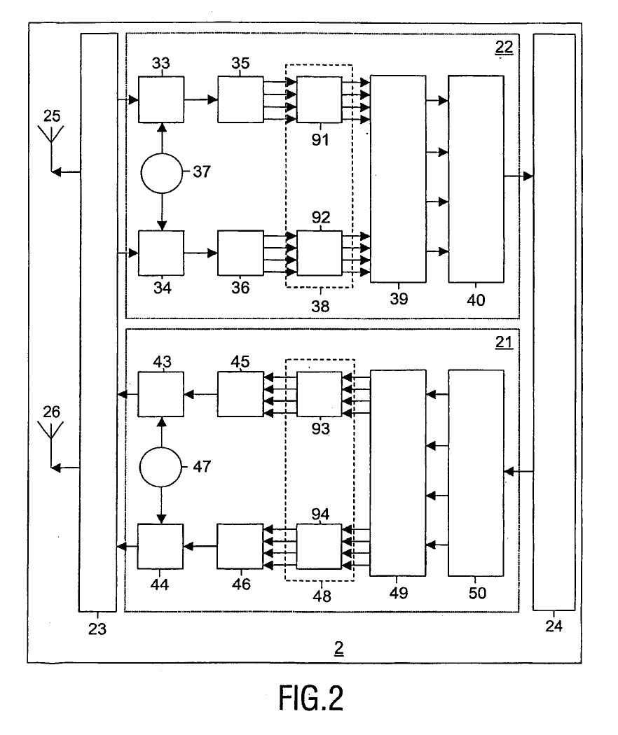

FIG. 2 shows in block diagram form a unit according to the invention comprising a receiver and a transmitter;

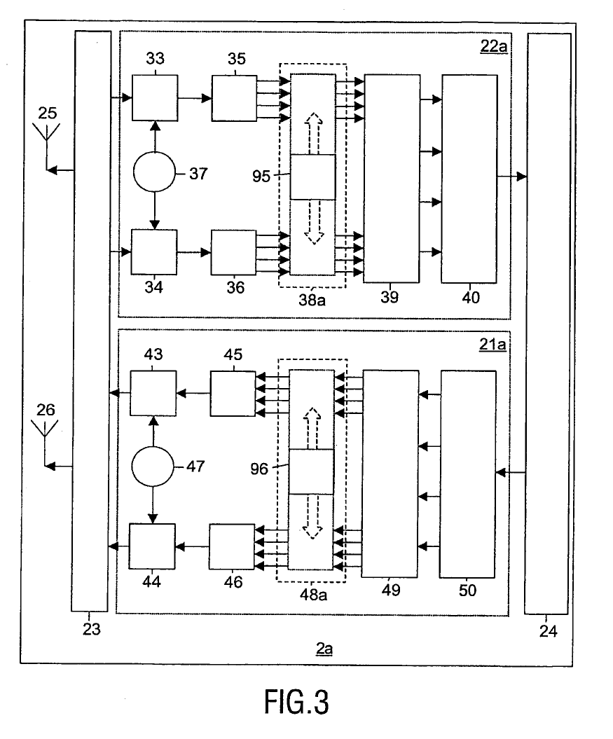

FIG. 3 shows in block diagram form an alternative unit according to the invention comprising a receiver and a transmitter;

FIG. 4 shows in block diagram form a processing module for a unit according to the invention; and

FIG. 5 shows in block diagram form an alternative processing module for a unit according to the invention.

The block diagram of the diversity system 3 according to the invention as shown in FIG. 1 comprises a first unit 1 and a second unit 2 for transmitting a signal 4 from the first unit 1 to the second unit 2 and for transmitting a return signal 5 from the second unit 2 to the first unit 1. Thereto, the first unit 1 comprises a transmitter 11 and a receiver 12 coupled to an antenna via a splitter 13. The second unit 2 comprises a receiver 22 and a transmitter 21, each one coupled to two antennas via an antenna switch 23. Each signal 4,5 comprises at least two sub-carriers.

The block diagram of the unit 2 according to the invention as shown in FIG. 2 comprises the receiver 22 and the transmitter 21 coupled to each other via a processor system 24. The receiver 22 is coupled to a first antenna 25 via the antenna switch 23, which is coupled to a first mixer 33 for frequency translating a first received antenna signal into a first (zero or low) intermediate frequency signal. Thereto, the first mixer 33 is further coupled to an oscillator 37 for receiving an oscillation signal. The first (zero or low) intermediate frequency signal is supplied via a first serial-to-parallel converter 35 to first inputs of a transforming module 38, like for example a fast fourier transformer. The receiver 22 is coupled to a second antenna 26 via the antenna switch 23, which is coupled to a second mixer 34 for frequency translating a second received antenna signal into a second (zero or low) intermediate frequency signal. Thereto, the second mixer 34 is further coupled to the oscillator 37 for receiving an oscillation signal. The second (zero or low) intermediate frequency signal is supplied via a second serial-to-parallel converter 36 to second inputs of the transforming module 38.

The transforming module 38 converts the received antenna signals into sub-carrier-vectors per sub-carrier and per antenna 25,26. Thereto, the transforming module 38 for example comprises a first fast fourier transformer 91 and a second fast fourier transformer 92, and supplies first sub-carrier-vectors received via the first antenna 25 to first inputs of a processing module 39 and supplies second sub-carrier-vectors received via the second antenna 26 to second inputs of the processing module 39 for processing the sub-carrier-vectors per sub-carrier. The processed sub-carrier-vectors coming from the processing module 39 are supplied to a demapper 40, like a prior art orthogonal frequency division multiplexing demapper, which sends its result signal to the processor system 24.

The transmitter 21 comprises a reverse processing module 49 for generating sub-carrier-vectors per sub-carrier and per antenna 25,26, in response to origin signals originating from the processor system 24 via a mapper 50, like a prior art orthogonal frequency division multiplexing mapper, whereby first subcarrier-vectors to be transmitted via a first antenna 25 are supplied per sub-carrier to first inputs of a reverse transforming module 48 and second sub -crier-vectors to be transmitted via a second antenna 26 are supplied per sub-carrier to second inputs of the reverse transforming module 48. The reverse transforming module 48 for example comprises a first inverse fast fourier transformer 93 and a second inverse fast fourier transformer 94. The converted first sub-carrier-vectors to be transmitted via the first antenna 25 are supplied via a first parallel-to-serial converter 45 to a first mixer 43, and the converted second subcarrier-vectors to be transmitted via the second antenna 26 are supplied via a second parallel-to-serial converter 46 to a second mixer 44. Both mixers 43,44 are further coupled to an oscillator 47 for receiving an oscillation signal, and frequency translate the converted sub-carrier-vectors into high frequency antenna signals to be transmitted via the antenna switch 23 and the antennas 25,26.

The block diagram of the alternative unit 2a according to the invention as shown in FIG. 3 corresponds with the block diagram of the unit 2 according to the invention as shown in FIG. 2 apart from the following. The unit 2a comprises a receiver 22a and a transmitter 21a, which correspond with the receiver 22 and the transmitter 21 as shown in FIG. 2 apart from the following. Firstly, in the receiver 22a the transforming module 38 is replaced by a transforming module 38a. This transforming module 38a comprises for example only one fast fourier transformer 95 which converts, during a first time-interval, first antenna signals received via the first antenna 25 and converts, during a second time-interval, second antenna signals received via the second antenna 26. This is for example done by using a switch and alternatingly coupling the outputs of the serial-to-parallel converters 35,36 to the fast fourier transformer 95 and alternatingly coupling the outputs of the fast fourier transformer 95 to the inputs of the processing module 39. Thereto, one or more of the serial-to-parallel converters 35,36 and/or the fast fourier transformer 95 and/or the processing module 39 may need buffers, or such buffers could be located between the blocks.

Secondly, in the transmitter 21a, the reverse transforming module 48 is replaced by a reverse transforming module 48a. This reverse transforming module 48a comprises for example only one inverse fast fourier transformer 96, which converts, during a first time-interval, first sub-carrier-vectors into first antenna signals to be transmitted via the first antenna 25 and converts, during a second time-interval, second sub-carrier-vectors into second antenna signals to be transmitted via the second antenna 26. This is for example done by using a switch and alternatingly coupling the outputs of the processing module 49 to the inverse fast fourier transformer 96 and alternatingly coupling the outputs of the inverse fast fourier transformer 96 to the inputs of the parallel-to-serial converters 45,46. One or more of these parallel-to-serial converters 45,46 and/or the inverse fast fourier transformer 96 and/or the processing module 49 may then need buffers, or such buffers could be located between the blocks. As a result, (inverse) transformers are saved or in other words chip area is saved, but the (inverse) transformers might need to operate at a higher speed.

By introducing the transforming module 38,38a for converting received antenna signals into sub-carrier-vectors per sub-carrier and per antenna, the received antenna signals are no longer splitted into arbitrary sub-bands (prior art), but they are splitted in accordance with the sub-carriers already present in the signal to be transmitted. The processing module 39 processes the sub-carrier-vectors per sub-carrier. As a result, at a relatively low complexity, the diversity system 3 will have an improved overall throughput. The thought behind this is, that the splitting of the received antenna signals into subbands having a bandwidth smaller than the sub-carriers increases the complexity and decreases the efficiency, and that the splitting of the received antenna signals into sub-bands having a bandwidth larger than the sub-carriers decreases the throughput improvement to be realised when splitting the received antenna signals in accordance with their own sub-carriers already present. According to the invention, the received antenna signals are splitted in accordance with borderlines naturally present.

By introducing the reverse transforming module 48,48a, the results of the converting and the processing of the received antenna signals in the receiver 22,22a are used in the reverse processing module 49 and in the reverse transforming module 48,48a for creating in the transmitter 2r,21a the antenna signals to be transmitted. This all takes place in the unit 2,2a, and, as an advantageous result, the unit 1 does no longer need to get a receiver coupled to at least two antennas and having a transforming module and a processing module (such a receiver would be necessary for improving a reception of the return signal 5 in correspondence with an improvement of a reception of the signal 4). In this case, the unit 2,2a for example corresponds with a kind of base station, which may be more expensive and which may have a larger power consumption than the unit 1, which for example corresponds with a mobile terminal. Of course, in case of both units 1,2,2a each comprising all four modules, the diversity system 3 will show an even more improved overall throughput.

The block diagram of a processing module 39 as shown in FIG. 4 comprises four switches 71-74 for switching four sub-carriers. Switch 71 (72,73,74) selects either a first (second,third,fourth) sub-carrier-vector originating from the transformer 91 or a first (second,third,fourth) sub-carrier-vector originating from the transformer 92. Thereto, the switches 71-74 are controlled through an algorithm cooperating with a sub-carrier quality assessment, like an error vector magnitude measurement. Instead of selection processes, more intelligent processes can be used, like for example linear combining and weighted combining. Such processes are common in the art and for example described in U.S. Pat. No. 5,528,581. Of course, generally, more or less switches may be present for switching more or less subcarriers, and not necessarily one-to-one.

The block diagram of an alternative processing module 39a as shown in FIG. 5 comprises a weighted combiner 81 for combining a first sub-carrier-vector originating from the transformer 91 and a first sub-carrier-vector originating from the transformer 92. To get an alpha value necessary for the combining in a weighted way, two error vector magnitude establishers 82,84 establish error vector magnitudes for both sub-carrier-vectors to determine quality figures for the sub-carrier-vectors, a ratio divider 83 divides these quality figures, a look-up table 85 converts a value of the divided quality figures into a proper value to be used as the alpha value. Optionally, an averager 86 may average the proper value over a number of symbols (with the transforming module 38,38a usually transforming per symbol like for example an orthogonal frequency division multiplexing symbol), to generate the alpha value. For the sake of clarity, the parts 81-86 are only shown for processing the first sub-carrier-vector, similar parts would be necessary for processing the second,third,fourth sub-carrier-vector, or a multiplexing mechanism as described for the (reverse) transforming modules 38a,48a is to be introduced.

The (reverse) transforming modules 38,38a,48,48a and the (reverse) processing modules 39,39a,49 may be realised through hardware, software or a mixture of both. Software may be run via a processor not shown or via the processor system 24. In case of the unit 2,2a being a base station, this processor system 24 may further comprise a fixed network connection, a switch etc. In case of the unit 2,2a being a mobile terminal, this processor system 24 may further comprise a filter, an amplifier, a man-machine-interface like a microphone, a loudspeaker, a keyboard, a display etc. The antennas 25,26 form one antenna pair used by the receiver 22,22a and the transmitter 21,21a via the antenna switch 23 (or an antenna duplexer or an antenna splitter), alternatively, different antenna pairs might be used.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to an advantage.

1. Diversity system (3) for transmitting a signal (4) comprising at least two sub-carriers from a first unit (1) to a second unit (2,2a), which first unit (1) comprises a transmitter (11) for transmitting the signal (4), which second unit (2,2a) comprises a receiver (22,22a) coupled to at least two antennas (25,26) located at different positions for receiving the signal (4), which receiver (22,22a) comprises a transforming module (38,38a) for converting received antenna signals into sub-carrier-vectors per sub-carrier and per antenna (25,26) and a processing module (39,39a) for processing the sub-carrier-vectors per sub-carrier.

2. Diversity system (3) as defined in claim 1, wherein the transforming module (38a) converts, during a first time-interval, first antenna signals received via a first antenna (25) and converts, during a second time-interval, second antenna signals received via a second antenna (26).

3. Diversity system (3) as defined in claim 1 for further transmitting a return signal (5) comprising at least two sub-carriers from the second unit (2,2a) to the first unit (1), which first unit (1) further comprises a receiver (12) for receiving the return signal (5), which second unit (2,2a) further comprises a transmitter (21,21a) coupled to at least two antennas (25,26) located at different positions for transmitting the return signal (5), which transmitter (21,21a) comprises a reverse processing module (49) for generating sub-carrier-vectors per sub-carrier and per antenna (25,26) and a reverse transforming module (48,48a) for converting the sub-carrier-vectors into antenna signals to be transmitted.

4. Diversity system (3) as defined in claim 3, wherein the reverse transforming module (48a) converts, during a first time-interval, first sub-carrier-vectors into first antenna signals to be transmitted via a first antenna (25) and converts, during a second time-interval, second sub-carrier-vectors into second antenna signals to be transmitted via a second antenna (26).

5. Unit (2,2a) for receiving a signal (4) comprising at least two sub-carriers from a further unit (1), which unit (2,2a) comprises a receiver (22,22a) coupled to at least two antennas (25,26) located at different positions for receiving the signal (4), which receiver (22,22a) comprises a transforming module (38,38a) for converting received antenna signals into sub-carrier-vectors per sub-carrier and per antenna (25,26) and a processing module (39,39a) for processing the sub-carrier-vectors per sub-carrier.

6. Unit (2a) as defined in claim 5, wherein the transforming module (38a) converts, during a first time-interval, first antenna signals received via a first antenna (25) and converts, during a second time-interval, second antenna signals received via a second antenna (26).

7. Unit (2,2a) as defined in claim 5 for further transmitting a return signal (5) comprising at least two sub-carriers to the other unit (1), which unit (2,2a) further comprises a transmitter (21,21a) coupled to at least two antennas (25,26) located at different positions for transmitting the return signal (5), which transmitter (21,21a) comprises a reverse processing module (49) for generating sub-carrier-vectors per sub-carrier and per antenna (25,26) and a reverse transforming module (48,48a) for converting the sub-carrier-vectors into antenna signals to be transmitted.

8. Unit (2a) as defined in claim 7, wherein the reverse transforming module (48a) converts, during a first time-interval, first sub-carrier-vectors into first antenna signals to be transmitted via a first antenna (25) and converts, during a second time-interval, second sub-carrier-vectors into second antenna signals to be transmitted via a second antenna (26).

9. Method for receiving a signal comprising at least two sub-carriers via at least two antennas (25,26) located at different positions, which method comprises a transforming step for converting received antenna signals into sub-carrier-vectors per sub-carrier and per antenna (25,26) and a processing step for processing the sub-carrier-vectors per sub-carrier.

10. Processor program product for receiving a signal comprising at least two sub-carriers via at least two antennas (25,26) located at different positions, which processor program product comprises a transforming function for converting received antenna signals into sub-carrier-vectors per sub-carrier and per antenna (25,26) and a processing function for processing the sub-carrier-vectors per sub-carrier.

11. Transforming module (38,38a) for use in a unit (2,2a) for receiving a signal (4) comprising at least two sub-carriers from a further unit (1), which unit (2,2a) comprises a receiver (22,22a) coupled to at least two antennas (25,26) located at different positions for receiving the signal (4), which receiver (22,22a) comprises the transforming module (38,38a) for converting received antenna signals into sub-carrier-vectors per sub-carrier and per antenna (25,26) and a processing module (39,39a) for processing the sub-carrier-vectors per sub-carrier.

12. Processing module (39,39a) for use in a unit (2,2a) for receiving a signal (4) comprising at least two sub-carriers from a further unit (1), which unit (2,2a) comprises a receiver (22,22a) coupled to at least two antennas (25,26) located at different positions for receiving the signal (4), which receiver (22,22a) comprises a transforming module (38,38a) for converting received antenna signals into sub-carrier-vectors per sub-carrier and per antenna (25,26) and the processing module (39,39a) for processing the sub-carrier-vectors per sub-carrier.
